(19) United States
(12) Patent Application Publication
(10) Pub. No.: US 2008/0310478 A1
(43) Pub. Date: Dec. 18, 2008

(54) Method and Apparatus for Synchronized Pressure and Temperature Determination in a High-Pressure Container by Means of Ultrasonic Transit Time Measurement

(76) Inventors: Stefan Mulders, Ditzingen-Heimerdingen (DE); Oliver Stoll, Reutlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/658,254

(22) PCT Filed: Jun. 2, 2005
(86) PCT No.: PCT/EP2005/052536

§ 371 Date: Jan. 24, 2007

(30) Foreign Application Priority Data
Jul. 30, 2004 (DE) 10 2004 037 135.0

(51) Int. Cl. G01K 11/24

(52) U.S. Cl. 374/142; 374/143; 374/E11.01

(57) ABSTRACT

Pressure and temperature inside a high-pressure container (common rail) are measured by means an ultrasonic emitter or an ultrasonic receiver which can detect the pressure inside the high-pressure container in a medium on the basis of the transit time of a pressure pulse. To this end, the ultrasonic receiver receives the pressure pulse, which propagates inside an additional element that is disposed between the ultrasonic emitter or ultrasonic receiver and the medium, and this propagation is ascertained accordingly in order to calculate a temperature from it.

The invention relates to a method for determining the pressure and temperature as generically defined by the preamble to claim 1 and to an apparatus for synchronous pressure and temperature determination as generically defined by the preamble to claim 6.

### PRIOR ART

Pressure determinations of liquids in high-pressure containers are necessary above all in measuring the diesel pressure in common rail systems or in gasoline injection technology, in which liquid pressures of up to 2000 bar occur. In other areas of industry as well, liquid pressures in high-pressure containers are measured. Various pressure measuring techniques are known for this.

As one example, it is possible to integrate a diaphragm or other deformable body as a pressure sensor into the wall of the high-pressure container and to measure its deflection by the so-called piezoresistive principle using pressure sensors.

A pressure sensor may also be mounted entirely inside the high-pressure container and thus directly in the medium to be measured, as is the case for example when piezoresistive materials are used. For this purpose, high-porosity RuO₂, for instance, is used, which under the influence of hydrostatic pressures changes its electrical transporting properties.

An apparatus for measuring a hydrostatic pressure within a common rail or direct gasoline injection is also known, which essentially comprises disposing an ultrasonic emitter with a corresponding ultrasonic receiver outside the common rail or direct gasoline injection, by means of which emitter and receiver the transit time of a pulse that is output by the ultrasonic sensor is measured. The ultrasound is propagated through the outer wall of the pressure container and then inside the fluid contained in the high-pressure container and is reflected at the end of the high-pressure container. The time that the ultrasonic pulse requires to traverse this defined distance is then measured, and from that the pulse speed is calculated, and from it the pressure in the liquid is determined.

### DISADVANTAGES OF THE PRIOR ART

The pulse speed, which is necessary here as a parameter for determining the pressure, is dependent on various factors. For one, it is dependent on the pressure inside the high-pressure container. A far more essential aspect is that the pulse speed is dependent on the temperature. It is therefore important, if an exact pulse speed is to be determined, that the actual temperature also be detected.

It is true that on the outer wall of the applicable pressure container, a thermocouple can be mounted and measures the temperature of the outer wall. Experiments have found, however, that the temperature of the outer wall is sometimes higher than the temperature of the actual medium located inside the pressure container. This in turn means that the pressure calculated from the pulse speeds does not correspond to the actual situation.

### OBJECT OF THE INVENTION

The object of the invention is therefore to create both an apparatus and a method by means of which the pressure and synchronously with the temperature present inside a high-pressure container as well can be ascertained by means of a measuring device which is located outside the high-pressure container.

### ATTAINMENT OF THE OBJECT

This object is attained by synchronously determining both the pressure and the temperature; the ultrasonic pulse emitted by an ultrasonic sensor excites a further element and likewise the time that the ultrasonic pulse traverses is measured, and this time is in turn determined in order to calculate the actual temperature prevailing inside the high-pressure container.

### ADVANTAGES OF THE INVENTION

The principle for measuring the pressure is based on the known relationship between the ultrasonic speed and the pressure in the vehicle medium.

If the transit time of an ultrasonic pulse is measured, then a conclusion can be drawn about the speed of sound and hence about the pressure of the vehicle medium.

A common rail (high-pressure container) is filled for test purposes, for instance with standard test oil in accordance with ISO 4113. The measuring means required are standard components, and hence inexpensive procurement is possible. The transit time measurement itself is done implicitly via an averaging measurement over the entire travel distance of the pressure pulse. The measurement is not interfered with by local individual pressure peaks of the kind that occur for instance in the vicinity of lead lines to injectors.

According to the invention, because the pressure measuring pulse generated passes not only through the medium located in the high-pressure container but also through the rest of the high-pressure container with a pulse, it is now provided that the reflection of this further pulse be measured and that this reflection in turn be set in relation to the pressure and to the speed of sound via a defined temperature relationship, so that based on these reflections caused by the further material, a conclusion can be drawn about the temperature.

One of the substantial advantages of the invention is that both the temperature and the pressure can be measured synchronously, or in other words at the same time. It is thus possible to calibrate the temperature course with respect to the transit time of the ultrasonic pulse.

A further substantial advantage of the invention is that without intervening in the pressure container, a measuring device which allows an exact pressure measurement and temperature measurement has been created using the simplest possible means.

One advantageous embodiment of the invention is designed such that the ultrasonic sensor is not disposed centrally but instead is disposed outside the center. The ultrasonic pulse generated therefore feeds not only into the vehicle medium but to a certain proportion also into the outer sheath of the common rail or high-pressure container. Since the speed of sound in metals is higher by a factor of 4-5 than in liquid, the two response pulses can be unambiguously distinguished from one another.

If the speed of sound in the tube wall has an unambiguous dependency on the temperature, then it can be used to determine the temperature. Conversely, the speed of sound is virtually independent of pressure. To this extent, the two effects can be distinguished from one another. The advantage is that the temperature is averaged along the length of the high-pressure container and is thus very close to the average temperature of the medium. Analogously, this construction can also be attained by a suitable large ultrasound head which feeds sufficient power into the wall of the high-pressure container. In this case, the ultrasonic head can also be installed centrally. The fed-in power can be adjusted via focusing properties of an ultrasound lens.

A further possibility of attaining the object is also provided. Advantageously, it is proposed that an interstice between the surface of an ultrasonic emitter and the coupling to the high-pressure container be filled with a further element. This element can be selected ideally in terms of its dependency and the speed of sound of the temperature. The sound thus feeds first into this further element. The sound is reflected at the first boundary face. This first response pulse is then used for temperature measurement. The second, markedly later response pulse is used for pressure measurement.

In a third version, it is advantageously proposed that between the ultrasonic emitter and the high-pressure container, an element is disposed that has a great, defined longitudinal expansion, which is dependent on the actual temperature. Advantageously, this can be plastic, which typically has very great longitudinal expansions, on the order of magnitude of 50 ppm/k. The change in thickness of this element changes the distance the sound travels. Thus the temperature can be determined. The material of the element must in this case be selected such that for the temperature range used, the speed of sound is if at all possible not dependent, or is only slightly dependent, on the temperature. The longitudinal expansion is compensated for on the back side of the ultrasonic head with a spring suspension, so that no major mechanical stresses act on the element (such stresses would prevent compression of the expansion element) and on the ultrasonic head.

A further advantageous embodiment of the invention provides that the boundary face with the liquid, at which the applicable ultrasonic pulse is reflected, is already used as the further element. However, this requires using a more strongly damped ultrasonic pulse generator, so that the applicable signal will not disappear as the excitation pulse fades.

In a very closely related version, it is provided that a thermocouple is cast integrally into the further element, in the region below the ultrasonic emitter. The thermocouple is located such that as little heat as possible can be projected to the outside. The measured temperature thus corresponds with high precision to that of the medium located in the high-pressure container.

In this respect it should also be noted that the coupling point preferably has the thinnest wall thickness of the high-pressure container. The thermal inertia is thus markedly reduced, compared to the outer wall.

Further advantageous features will become apparent from the ensuing descriptions, drawings, and claims.

### DRAWINGS

Shown are:

FIG. 1, a schematic illustration of a high-pressure container embodied as a common rail, with a sensor for pressure measurement, in accordance with the prior art;

FIG. 2, a schematic illustration of a first exemplary embodiment having a sensor for pressure and temperature measurement;

FIG. 3, a schematic illustration of a second exemplary embodiment having a sensor for pressure and temperature measurement;

FIG. 4, a schematic illustration of a third exemplary embodiment having a sensor for pressure and temperature measurement;

FIG. 5, a schematic illustration of a fourth exemplary embodiment having a sensor for pressure and temperature measurement;

FIG. 6, a schematic illustration of a fifth exemplary embodiment having a sensor for pressure and temperature measurement;

FIG. 7, a schematic illustration of a sixth exemplary embodiment having a sensor for pressure and temperature measurement.

### DESCRIPTION OF THE EXEMPLARY EMBODIMENTS

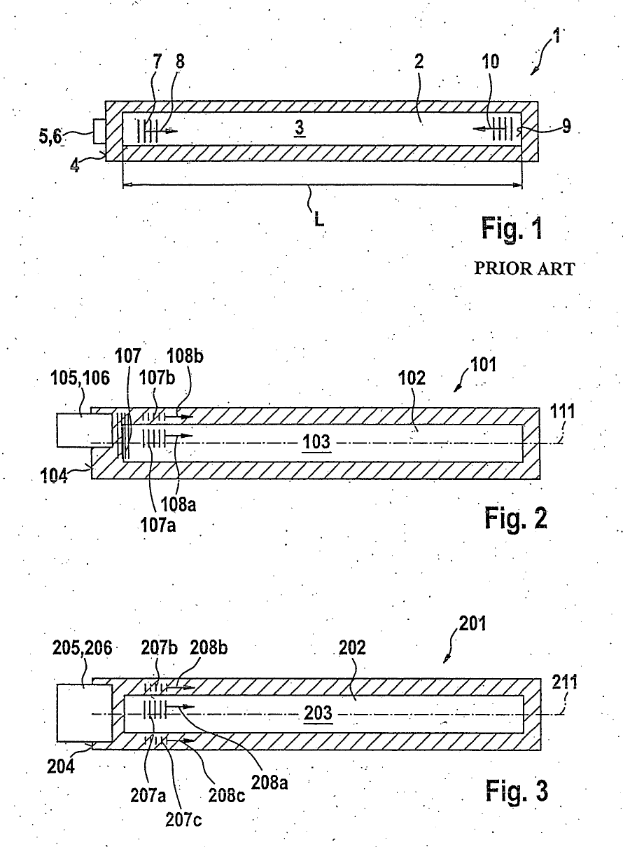

In FIG. 1, a high-pressure container 1 is shown. This high-pressure container 1 is self-contained and in its cavity 2 it includes a medium 3. On the face end 4 of the high-pressure container 1, an ultrasonic emitter 5 and an ultrasonic receiver 6 integrated with the ultrasonic emitter 5 are disposed—preferably embodied as a single component.

For pressure measurement, the ultrasonic emitter 5 emits a pressure pulse 7 in the direction of the arrow 8 from the ultrasonic emitter 5 into the medium 3. This pressure pulse is reflected on the side 9 diametrically opposite the ultrasonic emitter 5 and is sent in the direction of the arrow 10 and thus in the direction of the ultrasonic receiver 6. Once the reflected pressure pulse 7 has been received, the pressure inside the medium 3 can be calculated on the basis of the defined length L of the high-pressure container 1.

In FIG. 2, a first exemplary embodiment of an apparatus according to the invention is shown. This apparatus includes a high-pressure container 101 as well as a cavity 102, which is located inside the high-pressure container 101 and contains a medium 103. On the face end 104 of the high-pressure container 101, there is also an ultrasonic emitter and receiver 105, 106, which has both emitter and receiver properties. The ultrasonic sensor 105, 106 is not located symmetrically to the center axis 111 of the high-pressure container 101 but instead is offset from it. As a result of the generation of a pressure pulse 107 by the ultrasonic emitter 105, a first pressure pulse 107a is propagated in the direction of the arrow 108a within the medium 103. The pressure pulse 107 also splits into a pressure pulse 107b, which is propagated in the material of the high-pressure container 101 in the direction of the arrow 108b. The ultrasonic receiver 106 has the property that it is capable of receiving both pressure pulses 107a and 107b; based on the material (the pressure pulse 107b is capable of propagating faster within the metal comprising the high-pressure container 101), the pressure pulse 107b is the first to be received by the ultrasonic receiver 106. Because of this time slot, the transit time can be used for calculating the temperature.

In FIG. 3, an alternative embodiment is shown of an apparatus having a high-pressure container 201, a cavity 202, and a medium 203 located in the cavity 202. It is distinguished from the apparatus of FIG. 2 in that the ultrasonic receiver 205 and ultrasonic emitter 206 are disposed centrally, that is, on the center axis 211 of the high-pressure container 201. The dimensioning of the ultrasonic emitter 205 and ultrasonic receiver 206 is designed such that it extends over virtually the entire face end 204 of the high-pressure container 201, so that it can send and receive not only pressure pulses 207b and 207c, but also the pressure pulse 207a transmitted in the medium 203, in the directions of the arrows 208a, 208b and 208c.

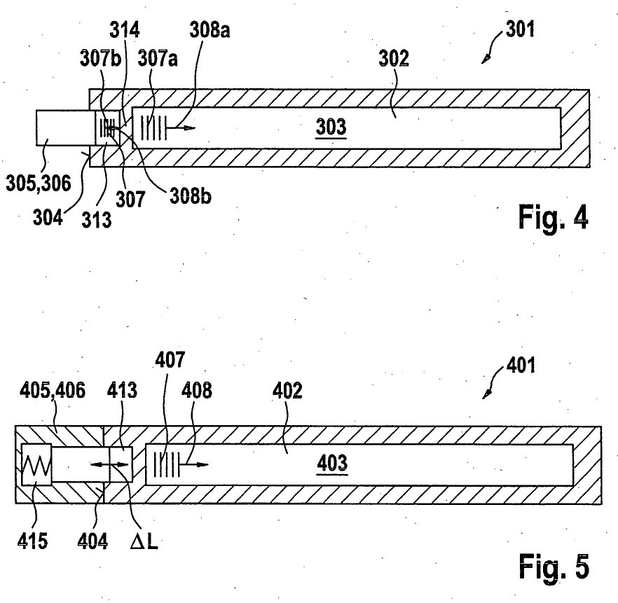

In FIG. 4, a further exemplary embodiment of an apparatus is shown. This apparatus includes a high-pressure container 301 and a cavity 302, located inside the high-pressure container 301, which contains a medium 303. An ultrasonic emitter and receiver 305, 306, which has both emitter and receiver properties, is disposed on the face end 304 of the high-pressure container 310, and between the ultrasonic emitter 305 and the ultrasonic receiver 306, an element 313 is disposed which has the property of sending the pressure pulse 307, generated from the ultrasonic emitter 306, onward as a pressure pulse 307a to the medium 303 in the direction of the arrow 308a. At a boundary layer 314 which is created between the element 313 and the cavity 302, part of the pressure pulse 307, namely 307b, which propagates in the direction of the arrow 308a, is reflected directly, so that the response pulse from the generated pressure pulse 307b arrives at the ultrasonic receiver 306 earlier than the response pulse of the further pressure pulse 307a.″

A further embodiment of the invention is shown in FIG. 5. The apparatus shown there likewise includes a high-pressure container 401; the high-pressure container 401 has a cavity 402 in which a medium 403 is located. The ultrasonic emitter 405 and receiver 406 is disposed on the face end 404 of the high-pressure container 401. Located between the ultrasonic emitter 405 and receiver 406 and the high-pressure container 401 is an element 413, which is designed as an intermediate material and is defined with a great and defined longitudinal expansion for measuring the temperature determination. This material can for instance be plastic, which typically has very great longitudinal expansions. The change in the spatial dimensions of this element 413 changes the distance traveled by the pressure pulse 407, emitted by the ultrasonic emitter 405, in the direction 408. As a result, the temperature can be determined. The material comprising the element 413 must be selected such that over the temperature range used, the speed of sound is if at all possible not dependent, or is only slightly dependent, on the temperature. The longitudinal expansion ΔL (T) is compensated for on the back side of the ultrasonic emitter 405 or receiver 406 with a spring element 415, so that no mechanical stresses act on either the element 413 or the ultrasonic emitter 405 or receiver 406.

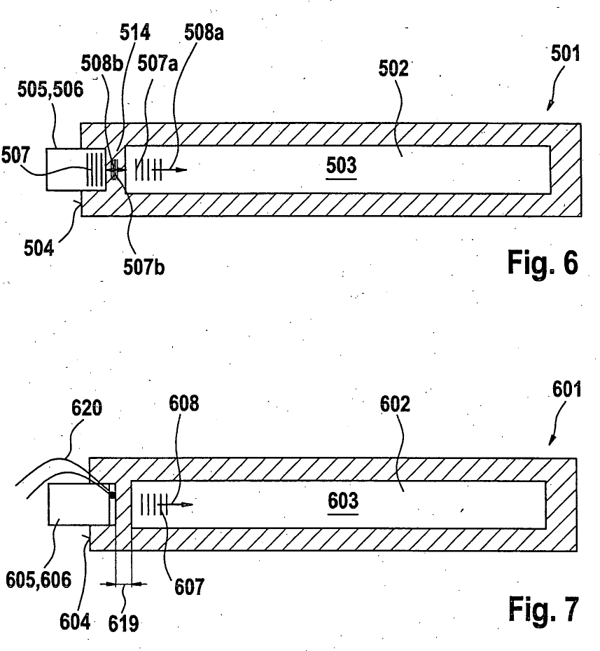

In the exemplary embodiment shown in FIG. 6 of an apparatus of the invention, a high-pressure container 501 is provided, which has a cavity 502 in which a medium 503 is disposed. Both an ultrasonic emitter 505 and an ultrasonic receiver 506 are disposed on the face end 504 of the high-pressure container 501. The ultrasonic emitter 505 generates a pressure pulse 507a, which is propagated in the direction of the arrow 508a within the medium 503. In addition, the pressure pulse 507, or a portion of the pressure pulse 507b, is reflected again at a boundary layer 514. The thus-generated returned signal of the pressure pulse 507b can in turn be used for calculating the temperature.

In FIG. 7, an alternative embodiment of the apparatus of the invention is shown. The apparatus shown here includes a pressure container 601, which forms a cavity 602. A medium 603 is stored in the cavity 602.

On the face end 604 of the high-pressure container 601, an ultrasonic emitter 605 and a corresponding ultrasonic receiver 606 are shown, which generates a pressure pulse 607 in the direction of the arrow 608. Between the ultrasonic emitter 605 and ultrasonic receiver 606 and the cavity 603, a thermocouple 620 is disposed, which measures the temperature of the medium 603. It should be noted that the thermocouple has a very short spacing 619 from the medium, so as to measure the immediate temperature.

1-8. (canceled)

9. In a method for synchronous determination of pressure and temperature in a high-pressure container of a common rail system or in a high-pressure container of a direct gasoline injection system, in which an ultrasonic device for generating and measuring an ultrasonic pulse is disposed outside the high-pressure container and the time that the ultrasonic pulse requires for traversing a defined distance in the high-pressure container is measured, and the pulse speed is calculated and from that a pressure in a medium of the high-pressure container is determined, the improvement comprising employing an ultrasonic device including an ultrasonic emitter and an ultrasonic receiver to synchronously excite a further element, and measuring the time which the ultrasonic pulse requires to traverse this further element is likewise measured by the ultrasonic device, which includes an ultrasonic emitter and an ultrasonic receiver, and utilizing that measurement to synchronously ascertain the temperature with the pressure measurement.

10. The method as defined by claim 9, wherein the ultrasonic pulse is conducted through the material of the high-pressure container as the further element.

11. An apparatus for synchronous determination of pressure and temperature in a high-pressure container of a common rail system or in a high-pressure container of a direct gasoline injection system, the apparatus comprising an ultrasonic device disposed outside the high-pressure container for generating and measuring an ultrasonic pulse, the ultrasonic device including means for detecting the time required for the ultrasonic pulse traverse a defined distance and calculating the pulse speed, and from that determining the pressure in the medium the ultrasonic device including means for synchronously exciting a further element, and means for measuring the time which the ultrasonic pulse requires to traverse the further element and from that ascertaining the temperature synchronously with the pressure measurement.

12. The apparatus as defined by claim 11, wherein the material of the high-pressure container forms the further element through which the ultrasonic pulse is conducted.

13. The apparatus as defined by claim 11, wherein the ultrasonic device is disposed offset from a center line of the high-pressure container.

14. The apparatus as defined by claim 12, wherein the ultrasonic device is disposed offset from a center line of the high-pressure container.

15. The apparatus as defined by claim 11, wherein the ultrasonic device is disposed flat on one face end of the high-pressure container.

16. The apparatus as defined by claim 12, wherein the ultrasonic device is disposed flat on one face end of the high-pressure container.

17. The apparatus as defined by claim 13, wherein the ultrasonic device is disposed flat on one face end of the high-pressure container.

18. The apparatus as defined by claim 11, wherein the further element is an intermediate material, which has the property, at an appropriate temperature, of performing a longitudinal expansion (ΔL).

19. The apparatus as defined by claim 12, wherein the further element is an intermediate material, which has the property, at an appropriate temperature, of performing a longitudinal expansion (ΔL).

20. The apparatus as defined by claim 13, wherein the further element is an intermediate material, which has the property, at an appropriate temperature, of performing a longitudinal expansion (ΔL).

21. The apparatus as defined by claim 14, wherein the further element is an intermediate material, which has the property, at an appropriate temperature, of performing a longitudinal expansion (ΔL).

22. The apparatus as defined by claim 15, wherein the further element is an intermediate material, which has the property, at an appropriate temperature, of performing a longitudinal expansion (ΔL).

23. The apparatus as defined by claim 16, wherein the further element is an intermediate material, which has the property, at an appropriate temperature, of performing a longitudinal expansion (ΔL).

24. The apparatus as defined by claim 17, wherein the further element is an intermediate material, which has the property, at an appropriate temperature, of performing a longitudinal expansion (ΔL).
